(19) United States
(12) Patent Application Publication
(10) Pub. No.: US 2014/0117650 A1
(43) Pub. Date: May 1, 2014

(54) GAS BAG FOR A VEHICLE OCCUPANT RESTRAINT SYSTEM AND METHOD FOR MANUFACTURING A GAS BAG

(71) Applicants: Ralf Glaab, Krombach (DE); Daniel Büttner, Hösbach (DE)

(72) Inventors: Ralf Glaab, Krombach (DE); Daniel Büttner, Hösbach (DE)

(73) Assignee: TAKATA AG, Aschaffenburg (DE)

(21) Appl. No.: 14/116,528

(22) PCT Filed: Jun. 5, 2012
(86) PCT No.: PCT/EP2012/060593

§ 371 Date: Nov. 8, 2013

(30) Foreign Application Priority Data
Jun. 8, 2011 (DE) 10 2011 050 932.1

(51) Int. Cl. B60R 21/233; B60R 21/237

(52) U.S. Cl. CPC B60R 21/233; B60R 21/237
USPC 280/729

(57) ABSTRACT

A gas bag for a vehicle occupant restraint system is provided. The gas bag comprises a first and a second gas bag layer which define an inflatable chamber of the gas bag. The first gas bag layer includes a first portion with an opening for at least partly introducing a gas generator and a second portion which is folded over towards the first portion and is connected with the first portion, so that the first and the second portion of the first gas bag layer form a receiving region for receiving a gas generator.

### CROSS-REFERENCE TO A RELATED APPLICATION

This application is a National Phase Patent Application of International Patent Application Number PCT/EP2012/060593, filed on Jun. 5, 2012, which claims priority of German Patent Application Number 10 2011 050 932.1, filed on Jun. 8, 2011.

### BACKGROUND

This invention relates to a gas bag for a vehicle occupant restraint system and to a method for manufacturing such gas bag.

From the prior art so-called 3D gas bags are known, which for example include a first gas bag layer, which is formed of two gas bag layer segments connected with each other, and a second gas bag layer connected with the first gas bag layer. The gas bag layer segments of the first gas bag layer are connected with each other via a first seam, which extends in a first plane, while the connection of the first with the second gas bag layer is made via a second seam, which extends in a second plane which is oriented obliquely or transversely to the first plane. In addition, e.g. from WO 2009/082305, there is known a gas bag with a connecting region protruding from the inflatable region of the gas bag for connecting a gas generator.

### SUMMARY

The problem underlying the invention consists in providing a gas bag which in terms of its protective effect is positioned in the vehicle interior as optimally as possible and which nevertheless can be manufactured rather easily.

According to an exemplary embodiment of the invention, there is provided a gas bag for a vehicle occupant restraint system, comprising
a first and a second gas bag layer which define an inflatable chamber of the gas bag, wherein
the first gas bag layer includes a first portion with an opening for at least partly introducing a gas generator and a second portion which is folded over towards the first portion and is connected with the first portion, so that the first and the second portion of the first gas bag layer form a receiving region for receiving a gas generator.

The receiving region formed by the first gas bag layer accordingly realizes a connection neck of the gas bag, via which a gas generator is coupled to the gas bag and the gas generated by the gas generator can be blown into the gas bag.

In particular, the second portion connected with the first portion of the first gas bag layer is folded over at least approximately by 180°, so that it e.g. at least sectionally rests against the first portion. The receiving region formed of the first and second portions of the first gas bag layer in particular protrudes from a base region formed by the remaining region of the first gas bag layer (and correspondingly also from the second gas bag layer).

The opening for introducing the gas generator in particular has a circular cross-section, wherein the invention is of course not limited to a particular geometry of the opening (“inflation orifice”), but can rather be adapted to the gas generator to be used (e.g. in the form of a pot-shaped or tubular gas generator).

Furthermore, the folded second portion of the first gas bag layer is designed such that it extends beyond the opening of the first portion.

Beside the opening for receiving a gas generator, the receiving region can include fastening structures (for example mounting openings) which serve for leading through fastening means (for example bolts and/or screws).

The opening for the gas generator in particular extends in a plane which—in relation to the inflated condition of the gas bag—extends vertically or transversely to the main plane of extension of the second gas bag layer. “Main plane of extension” is understood to be a plane along which the second gas bag layer has its greatest expansion. For example, the main plane of extension of the second gas bag layer (in relation to the inflated condition of the gas bag) is a plane which at least approximately is defined by the vehicle height direction and transversal vehicle direction. It is conceivable that after inflation of the gas bag the second gas bag layer slightly bulges, i.e. also has a certain expansion in longitudinal vehicle direction.

According to another exemplary development of the invention the receiving region is defined by two seams spaced from each other, via which the first and the second portion of the first gas bag layer are connected with each other. For example, the seams extend in a plane (which corresponds to the main plane of extension of the receiving region in the non-inflated condition of the gas bag), which in the inflated condition of the gas bag extends obliquely or vertically to the main plane of extension of the second gas bag layer. In particular, the opening for the gas generator also is located in this plane.

In another exemplary aspect of the invention, the receiving region for the gas generator is positioned at a certain distance from an edge of the gas bag (in particular of the mentioned base region of the first gas bag layer). The distance of the receiving region is related e.g. to a fixed end portion (foot) of the receiving region, with which it opens into the base region of the first gas bag layer formed by the remaining gas bag (i.e. via which the receiving region is in particular integrally connected with the base region).

The location of this fixed end portion of the receiving region in particular is determined by the length and position of the seams via which the first and the second portion of the first gas bag layer are connected with each other when manufacturing the receiving region. For example, the fixed end portion of the receiving region opens into the base region of the first gas bag layer on an imaginary sectional line along which the main plane of extension of the receiving region (i.e. the plane in which the seams for connecting the first and the second portion of the first gas bag layer extend) intersects the main plane of extension of the base region of the first gas bag player spread out flat (or of the second gas bag layer spread out flat).

The base region of the first gas bag layer in particular includes a first edge portion which—in relation to the condition mounted in the vehicle and inflated—faces the vehicle floor, and a second edge portion which faces the vehicle roof, wherein the receiving region is positioned such that its end portion opening into the base region has a distance from the first edge portion which amounts to more than half of the expansion (length) L of the base region of the first gas bag layer spread out flat, wherein the expansion L between the first and the second edge portion of the base region of the first gas bag layer and the distance L₁ is determined in particular in relation to the center of the receiving region between its seams (via which the first and the second portion of the first gas bag layer are connected with each other), e.g. along an axis of symmetry.

The “first edge portion” in particular is a portion of the base region of the first gas bag layer, which in relation to the condition of the gas bag mounted in the vehicle and inflated has the smallest distance to the vehicle floor, while the “second edge portion” is a portion of the base region which has the smallest distance to the vehicle roof. In particular, the receiving region for receiving the gas generator is positioned such that in the mounted condition of the gas bag it extends above—in relation to the vehicle height direction—the gas bag center between the first and the second edge portion of the base region of the first gas bag layer and/or between corresponding edge regions of the gas bag.

In another example, the distance L₁ of the receiving region from the first edge region amounts to at least half of and not more than 0.8 times, in particular 0.6 times, the expansion L.

According to another exemplary aspect of the invention, the receiving portion—in relation to the non-inflated condition of the gas bag—has a maximum expansion (height) X, wherein the center of the opening for introducing a gas generator is positioned at a distance X₁ from the end portion opening into the base region, which at least approximately amounts to half of the maximum expansion X of the receiving region. The “maximum expansion” of the receiving portion is determined from the fixed end portion of the receiving portion opening into the base region of the first gas bag layer and vertically to the extension of this fixed end portion; for example, the expansion is the maximum distance between the fixed and a free end portion of the receiving portion.

For example, the distance X₁ amounts to at least 0.4 times and not more than 0.8 times the maximum expansion X of the receiving region.

According to another exemplary aspect of the invention, the first gas bag layer is formed of at least two gas bag layer segments which are connected with each other via at least one seam. It is conceivable that with one section each the gas bag layer segments are overlappingly connected with each other, in particular such that a reinforcement of the receiving region (to be created by connecting the first and the second portion of the first gas bag layer) is obtained.

It is of course not absolutely necessary that the first gas bag layer is formed of a plurality of separate gas bag layer segments. Rather, it is also conceivable that the first gas bag layer is formed in one piece. Examples of suitable gas bag layer blanks will be explained below. The first gas bag layer in particular is connected with the second gas bag layer along a circumferential seam.

The gas bag according to the invention in particular is formed as front gas bag (driver or passenger gas bag). The invention also relates to a vehicle with a gas bag as described above.

Furthermore, the invention also relates to a method for manufacturing a gas bag, with the following steps:
providing a first and a second gas bag layer, wherein the first gas bag layer includes a first portion with an opening for at least partly introducing a gas generator;
folding over a second portion of the first gas bag layer towards the first portion; and
connecting the second with the first portion, so that the first and the second portion of the first gas bag layer form a receiving region for receiving a gas generator.

### BRIEF DESCRIPTION OF THE DRAWINGS

The invention will be explained in detail by means of exemplary embodiments with reference to the Figures.

FIG. 1 shows blanks for gas bag layers of a gas bag according to the invention.

FIGS. 2A to 2G show step of the manufacture of a gas bag according to the invention.

FIG. 3 shows a gas bag according to an exemplary embodiment of the invention.

FIG. 4 shows the gas bag of FIG. 3 in the condition mounted in the vehicle and inflated.

FIG. 5 shows a modification of the first gas bag layer.

FIGS. 6A to 6D show steps in the manufacture of a gas bag according to the invention by using the gas bag layer of FIG. 6.

FIG. 7 shows a further modification of the first gas bag layer.

FIGS. 8A to 8D show steps in the manufacture of a gas bag according to the invention by using the first gas bag layer of FIG. 7.

### DETAILED DESCRIPTION

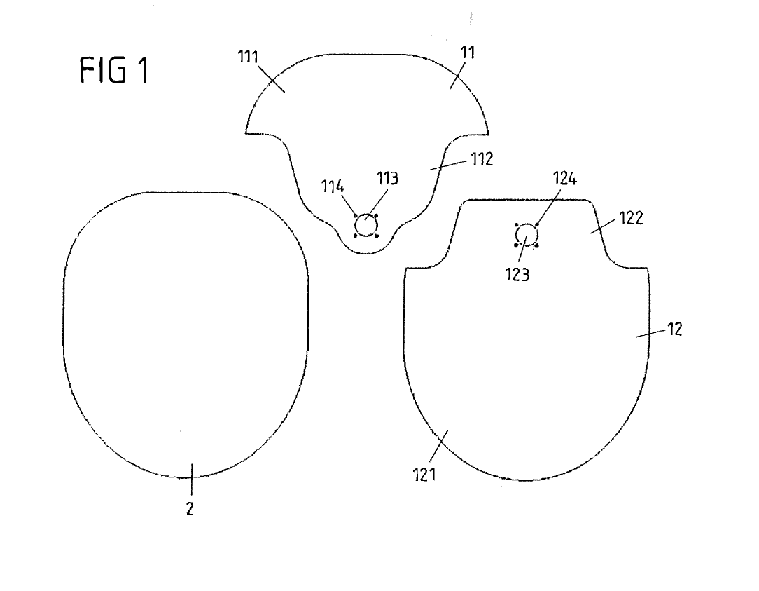

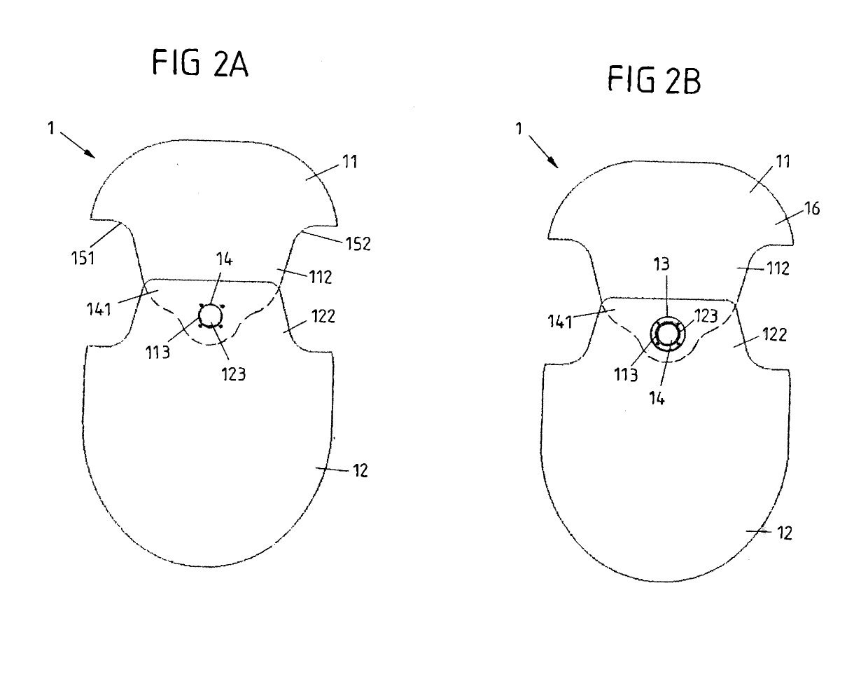

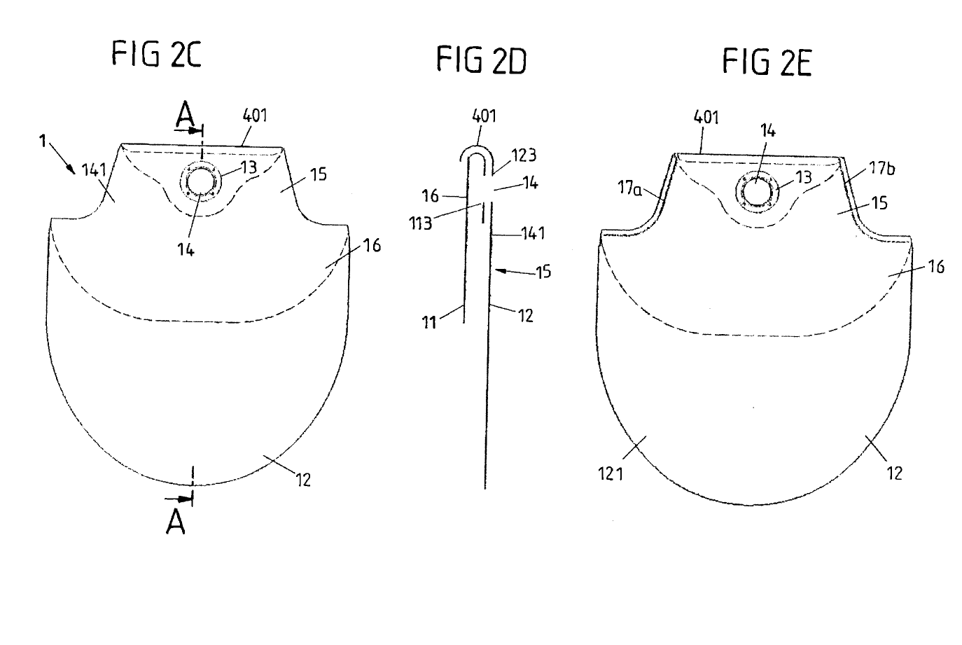

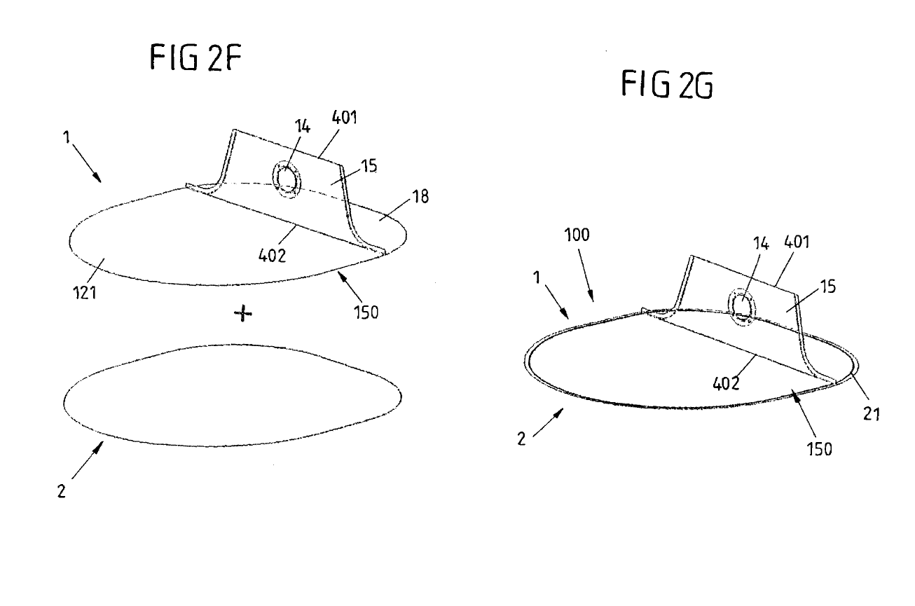

FIG. 1 on the one hand shows two gas bag blanks which form a first and a second gas bag layer segment 11, 12, which are to be connected with each other to form a first gas bag layer 1 (cf. FIGS. 2A, 2B). On the other hand, FIG. 1 shows a blank for a second gas bag layer 2. The blanks in particular are made of a woven material.

The segments 11, 12 each include a base body 111, 121, from which a narrower portion 112, 122 protrudes. In the narrower portions 112, 122 a circular opening 113, 123 each is provided, which is surrounded by four smaller openings 114, 124 each.

The two segments 11, 12 are arranged such that the narrower portions 112, 122 partly overlap and the congruent openings 113, 123 as well as the openings 114, 124 are aligned with each other (FIG. 2A). At the same time, indentations 151, 152 are formed, whose contour is determined by a lateral edge of the first and the second segment 11, 12 (each of the narrower portions 112, 122).

Subsequently, the segments 11, 12 are connected with each other via a circular seam 13, which concentrically surrounds the openings 113, 123 and which extends outside the smaller openings 114, 124, and in this way generate the first gas bag layer 1. The seam 13 in particular is formed as sewn seam, wherein it is also conceivable, however, that a glued or welded seam is used. Due to the portions 112, 122 overlappingly connected with each other, a reinforcement (multilayer structure) is obtained in the region of the overlapping openings 113, 123.

The openings 113, 123 aligned with each other form a continuous opening 14 in a (first) portion 141 of the first gas bag layer 1, which serves for receiving a gas generator (not shown), while the smaller openings 114, 124 form mounting openings which can be utilized for fixing the gas generator at the gas bag.

After connecting the segments 11, 12, a second portion 16 of the manufactured first gas bag layer 1 is folded over (to the rear) and towards the first portion 141, so that the portion 16 extends beyond the opening 14 (on a side of the first portion 141 facing away from the front gas bag layer segment 12) and the lateral edges of the segments 11, 12 coincide in the region of the indentations 151, 152. A section along the axis of symmetry A-A of the first gas bag layer 1 is shown in FIG. 2D.

A part of the folded portion 16 is connected with the first portion 141 of the first gas bag layer 1 via seams 17a, 17b (FIG. 2E), in order to produce a receiving portion 15 for receiving a gas generator. The receiving portion 15 has a horizontally (vertically to the axis of symmetry A-A) extending free end portion 401, from which on both sides of the end portion 401 a lateral edge of the receiving portion 15, which via a curvature transitions into an again horizontally extending portion, each protrudes, which extends obliquely to the axis of symmetry A-A. The seams 17a, 17b each follow the contour of the receiving region 15.

After connecting the second portion 16 with the first portion 141 via the seams 17a, 17b, a partial region 18 of the first gas bag layer 1 not connected with the receiving region 15 is folded back, so that it substantially is located in one plane with the broader portion 121 of the segment 12 (upper representation of FIG. 2F). As a result, the receiving region 15 protrudes from a base region 150 formed by the remaining region of the first gas bag layer (outside the receiving region 15) (FIG. 2G), wherein the receiving region 15 is integrally connected with the base region 150 via a fixed end portion 402.

After manufacturing the receiving region 15, the first gas bag layer 1 (i.e. its base region 150) is connected with the second gas bag layer 2 by means of a circumferential seam 21, whereby the gas bag 100 according to the invention as shown in FIG. 2G is obtained.

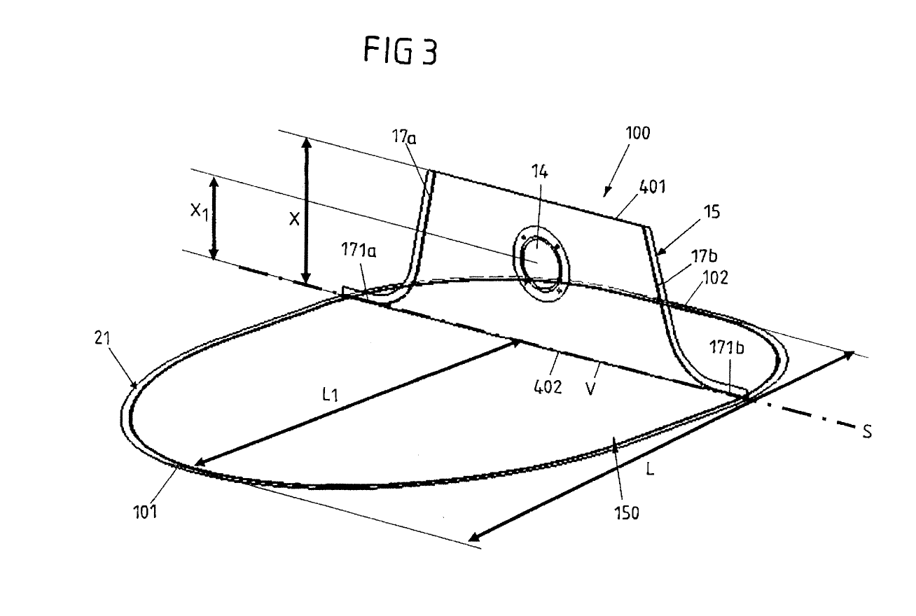

FIG. 3 shows the non-inflated gas bag 100 of FIG. 2G in an enlarged representation, wherein the base region 150 of the first gas bag layer 1 and the second gas bag layer 2 are in a condition spread out flat.

The base region 150 of the first gas bag layer (and correspondingly the second gas bag layer 2 or the gas bag 100) has a first edge region 101 which in the inflated condition of the gas bag mounted in the vehicle faces the vehicle floor, and a second edge region 102 which is located opposite the first edge region 101 along an axis of symmetry of the gas bag 100 (axis A-A in FIG. 2C). In the inflated and mounted condition of the gas bag, the second edge region 102 faces a vehicle headliner.

The gas bag 100 (the base region 150 of the first gas bag layer) has an expansion L between the edge portions 101, 102 (as seen along the axis of symmetry). The expansion L thus corresponds to the maximum longitudinal expansion of the gas bag along a direction parallel to the axis of symmetry of the gas bag. The receiving region 15 is positioned at a certain distance from the first and the second edge portion 101, 102, namely such that the fixed end portion 402 of the receiving portion 15 is positioned at a distance L₁ from the first edge portion 101, which amounts to at least half of the expansion L of the base region 150.

In other words, the sectional line S of a plane along which the receiving portion 15 extends (or the seams 17a, 17b) with a plane along which the base region 150 of the first gas bag layer (in the condition spread out flat) extends is located at a distance L₁ from the first edge portion 101, which amounts to at least half of the expansion L.

It is also conceivable that the distance L₁ amounts to 0.5 times to 0.8 times the expansion L, in particular the distance L₁ amounts to 0.6 times the expansion L.

Furthermore, the receiving region 15 has a height X, i.e. a maximum expansion between the fixed end portion 402 and the free end portion 401 (free end) measured along the main plane of extension of the receiving region 15 (or the plane in which the seams 17a, 17b are located) and vertically to the fixed end portion 402 (or to the sectional line S). The location of the fixed end portion 402 is determined by the length of the seams 17a, 17b, i.e. by the location of their respective end 171a, 171b facing the base region 150 of the first gas bag layer, wherein the course of an imaginary connecting line V through the ends 171a, 171b corresponds to the course of the fixed end portion 402. The position of the free end portion 402 is given by the course of the edge of the end portion 402 terminating the receiving portion 15.

The opening 14 for receiving a gas generator now is positioned such that its center is located at a distance X₁, which amounts to half or at least half of the height X of the receiving region 15. It is also conceivable that the center of the opening 14 is located at a distance X, which amounts to 0.4 to 0.8 times the height X of the receiving region 15.

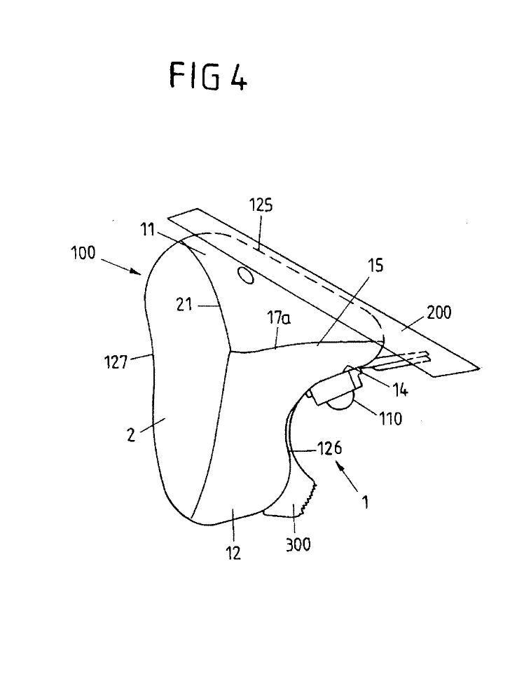

FIG. 4 shows the gas bag 100 according to the invention as shown in the preceding Figures in its condition mounted in the vehicle and inflated. The inflated chamber of the gas bag 100 is defined by the first gas bag layer 1, i.e. the gas bag layer segments 11, 12, and by the second gas bag layer 2.

A gas generator 110 is at least partly inserted into the opening 14 of the receiving portion 15 and fixed at the receiving portion 15 in particular via the mounting openings 114, 124 (FIG. 1).

The gas bag is designed such that the second gas bag layer 2 (or an edge 127 facing the vehicle tail) substantially extends along a plane defined by the vehicle height direction and transversal vehicle direction, i.e. its main plane of extension is formed by the plane defined by the vehicle height direction and transversal vehicle direction. However, this is of course not absolutely necessary, and it is also conceivable that the second gas bag layer 2 is oriented obliquely to the plane defined by vehicle height direction and transversal vehicle direction.

The plane in which the seams 17a, 17b extend, via which the first and the second portion 141, 16 of the first gas bag layer 1 are connected for producing the receiving portion 15, substantially extends vertically to the main plane of extension of the second gas bag layer 2 (approximately parallel to a plane defined by the vehicle height direction and longitudinal vehicle direction). In particular, it can be seen that the plane in which the seams 17a, 17b extend is located above the center of the second gas bag layer 2—in relation to the vehicle height direction. This is achieved by the design of the gas bag as shown in FIG. 3, so that the inflated gas bag assumes a rather good protective position in the vehicle interior (i.e. represents an optimized “3D gas bag”).

For example, the first gas bag layer segment 11 of the first gas bag layer 1 is designed such that it forms a side 125 of the gas bag 100, which at least approximately extends along a windshield 200 of the vehicle. The second gas bag segment 12, on the other hand, is formed such that with one side 126 it follows a contour of a dashboard and in particular can rest against the dashboard.

The gas bag shown in FIG. 4 is a passenger gas bag, wherein the gas generator can be formed in the form of a tubular or pot-shaped gas generator. The invention, however, is of course not limited to a passenger gas bag, but can generally be used for front gas bags, i.e. also for a driver gas bag.

An edge 127 of the second gas bag layer 2 facing the vehicle rear is oriented substantially parallel or slightly obliquely to a plane which is defined by the vehicle height direction or the transversal vehicle direction.

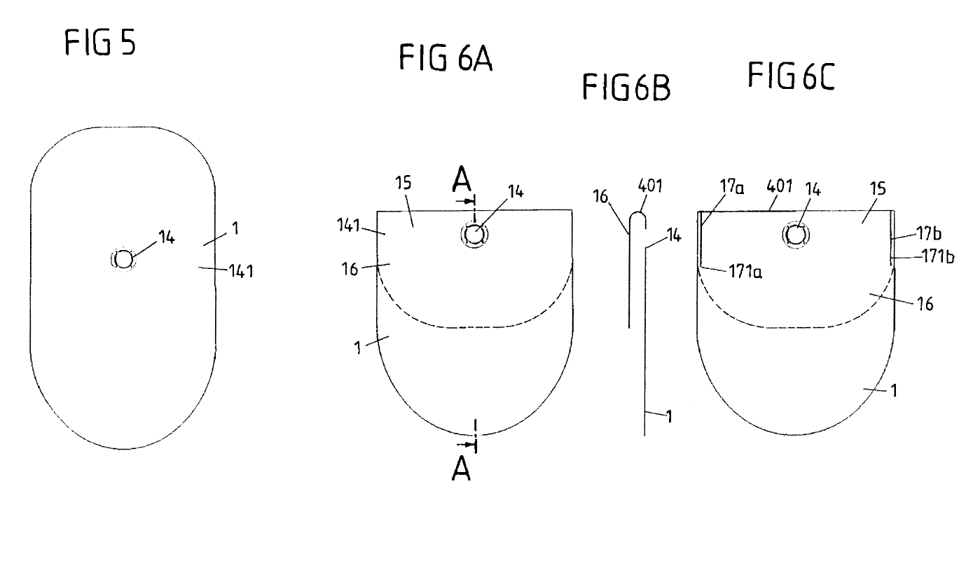

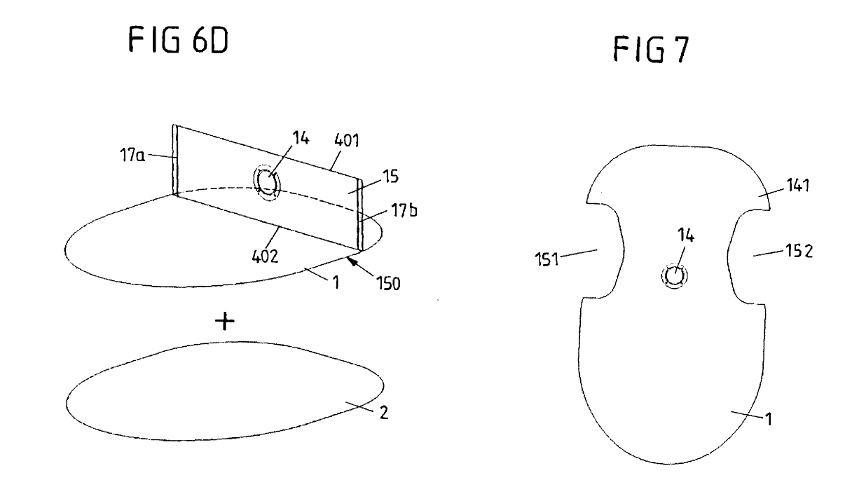

FIGS. 5 and 6A to 6D relate to a further embodiment of the gas bag of the invention, according to which the first gas bag layer 1 is formed in one piece in contrast to FIG. 1, i.e. is formed of a single material blank.

The first gas bag layer 1 in turn includes a first portion 141 with an opening 14 for introducing a gas generator (not shown). Furthermore, for manufacturing the receiving portion 15 of the gas bag like in the example of FIGS. 1 and 2 a second portion 16 is folded over (FIGS. 6A, 6B) and connected with the first portion 141 by means of two linearly designed seams 17a, 17b spaced from each other (FIG. 6C).

The seams 17a, 17b each extend along a lateral edge of the first gas bag layer 1, i.e. along an axis of symmetry of a first gas bag layer 1. The length of the seams 17a, 17b here determines the height of the receiving region 15, i.e. the expansion between end portions 171a, 171b of the seams 17a, 17b and the free end portion 402 of the receiving region 15 protruding like a tab from the base region 150 of the first gas bag layer 1. The base region 150 of the first gas bag layer 1 then is connected with the second gas bag layer 2 by means of a circumferential seam analogous to FIG. 2F.

A further possibility for realizing the first gas bag layer 1 is shown in FIG. 7. Accordingly, the first gas bag layer 1 likewise is formed in one piece, but does not have linear lateral edges like the first gas bag layer of FIG. 5, but similar (or identically) to the first gas bag layer of FIG. 2A lateral indentations 151, 152, which after folding over the second portion 16 and connecting the same with the first portion 141 for manufacturing the connecting region 15 laterally define the connecting region 15. Due to the indentations 151, 152 the receiving region 15 is narrower than the base region 150 of the first gas bag layer 1.

The seams 17a, 17b extend along the contour of the indentations 151, 152, i.e. they each have an upper portion oriented obliquely to the axis of symmetry and a lower portion oriented at least approximately vertically to the axis of symmetry, wherein the upper and the lower portion each are connected with each other via a curvature.

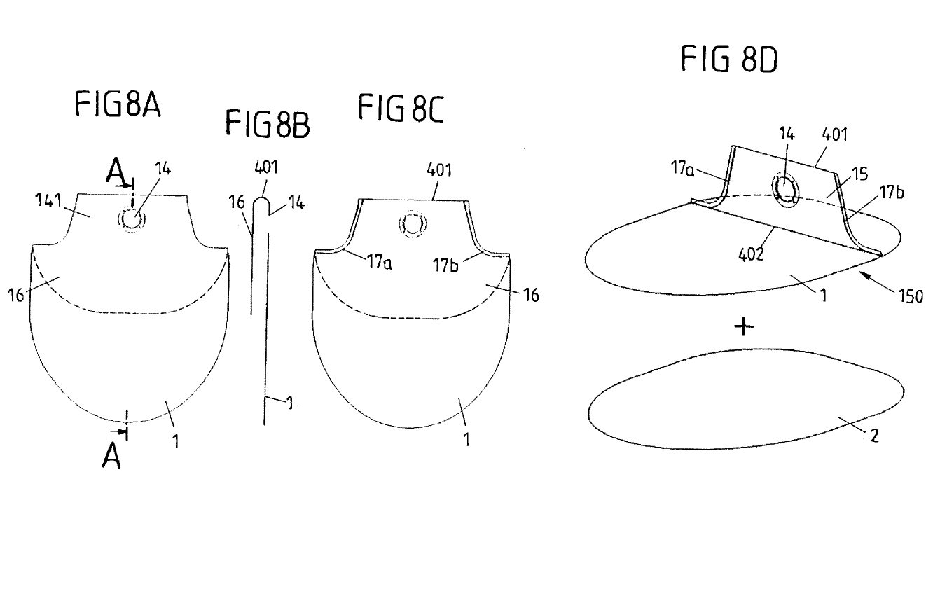

After manufacturing the receiving region 15, the base region 150 of the first gas bag layer 1 in turn is attached to the second gas bag layer 2 with a circumferential seam (cf. FIGS. 8A-8D).

It should be noted that all or at least some of the seams which are produced for manufacturing the gas bag also can be designed as glued or welded seam.

1-15. (canceled)

16. A gas bag for a vehicle occupant restraint system, comprising
a first and a second gas bag layer which define an inflatable chamber of the gas bag, wherein
the first gas bag layer includes a first portion with an opening for at least partly introducing a gas generator and a second portion which is folded over towards the first portion and is connected with the first portion, so that the first and the second portion of the first gas bag layer form a receiving region for receiving a gas genera-tor.

17. The gas bag according to claim 16, wherein the second portion of the first gas bag layer connected with the first portion is folded over at least approximately by 180°.

18. The gas bag according to claim 16, wherein the second portion of the first gas bag layer extends beyond the opening in the first portion.

19. The gas bag according to claim 16, wherein the opening in the first gas bag layer extends in a plane which—in relation to the inflated condition of the gas bag—ex-tends vertically or transversely to the main plane of extension of the second gas bag layer.

20. The gas bag according to claim 16, wherein the receiving region is defined by two seams spaced from each other, via which the second portion of the first gas bag layer is connected with the first portion.

21. The gas bag according to claim 20, wherein the seams extend in a plane which in the inflated condition of the gas bag extends obliquely or vertically to the main plane of extension of the second gas bag layer.

22. The gas bag according to claim 16, wherein the receiving region protrudes from a base region of the first gas bag layer, which is formed by the remaining first gas bag layer.

23. The gas bag according to claim 22, wherein
the receiving region opens into the base region with an end portion;
the base region of the first gas bag layer includes a first edge portion which—in relation to the condition of the gas bag mounted in the vehicle and inflated—faces the vehicle floor, and a second edge portion which faces the vehicle roof, and wherein
the receiving region is positioned such that its end portion opening into the base region has a distance L1 from the first edge portion, which amounts to more than half of the expansion L of the base region of the first gas bag layer spread out flat between its first and its second edge portion.

24. The gas bag according to claim 23, wherein the distance L1 amounts to at least half of and not more than 0.8 times the expansion L.

25. The gas bag according to claim 22, wherein the receiving portion—in relation to the non-inflated condition of the gas bag—has a maximum expansion X between its end portion opening into the base region of the first gas bag layer and a further, free end portion, wherein the center of the opening for introducing a gas generator is positioned at a distance X1 from the end portion opening into the base region, which at least approximately amounts to half of the maximum expansion X of the receiving region.

26. The gas bag according to claim 25, wherein the distance X1 amounts to at least 0.4 times and not more than 0.8 times the maximum expansion X of the receiving re-gion.

27. The gas bag according to claim 16, wherein the first gas bag layer is formed of at least two gas bag layer segments which are connected with each other via at least one seam.

28. The gas bag according to claim 16, wherein the first gas bag layer is formed in one piece.

29. The gas bag according to claim 16, wherein the first gas bag layer is connected with the second gas bag layer along a circumferential seam.

30. A method for manufacturing a gas bag according to claim 16, with the following steps:
providing a first and a second gas bag layer, wherein the first gas bag layer includes a first portion with an opening for at least partly introducing a gas generator;
folding over a second portion of the first gas bag layer towards the first portion; and
connecting the second with the first portion, so that the first and the second portion of the first gas bag layer form a receiving region for receiving a gas generator.
